(19) United States
(12) Patent Application Publication
(10) Pub. No.: US 2013/0149558 A1
(43) Pub. Date: Jun. 13, 2013

(54) MAGNETIC MEDIA HAVING ULTRA THIN BONDED LUBRICATION LAYER

(71) Applicants: Xing-Cai Guo, Tracy, CA (US); Thomas E. Karis, Aromas, CA (US); Bruno Marchon, Palo Alto, CA (US)

(72) Inventors: Xing-Cai Guo, Tracy, CA (US); Thomas E. Karis, Aromas, CA (US); Bruno Marchon, Palo Alto, CA (US)

(73) Assignee: Hitachi Global Storage Technologies Netherlands B.V., Amsterdam (NL)

(21) Appl. No.: 13/316,328

(22) Filed: Dec. 9, 2011

(51) Int. Cl. G11B 5/725; G11B 5/84

(52) U.S. Cl. 428/800; 427/127

(57) ABSTRACT

A method for manufacturing a magnetic media having an extremely thin lubricant layer on a magnetic media. The thin lubricant layer decreases magnetic spacing to maximize magnetic performance of the magnetic data recording system. The lubricant layer is formed by first depositing a lubricant that includes two different lubricant materials, one bonded and the other non-bonded. After lubricant deposition a burnishing process can be performed, with the lubricant being thick enough for effective burnishing. Then, the disk is exposed to a solvent vapor, which removes most of the lubricant leaving only a very thin layer of the bonded lubricant material.

### FIELD OF THE INVENTION

The present invention relates to magnetic data recording and more particularly a method for manufacturing a magnetic media having an ultra-thin lubrication layer for reduced magnetic spacing.

### BACKGROUND OF THE INVENTION

A key component of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). When the slider rides on the air bearing, the write and read heads are employed for writing magnetic impressions to and reading magnetic impressions from the rotating disk. The read and write heads are connected to processing circuitry that operates according to a computer program to implement the writing and reading functions.

One parameter that greatly affects the performance of the magnetic recording system is the magnetic spacing between the read and write heads and the magnetic recording layer of the media. The strength of the magnetic signal decreases exponentially with increasing magnetic spacing. However, in order for the magnetic data storage system to operate reliably, certain non-magnetic layers must be provided over the magnetic recording layer of the magnetic medium. Such layers can include a protective overcoat layer, and a lubrication layer. Although these layers are necessary to the reliable operation of the system, their presence actually decreases the performance of the system by increasing magnetic spacing.

### SUMMARY OF THE INVENTION

The present invention provides a magnetic media for magnetic data recording that includes a magnetic disk having a lubricant layer formed thereon, the lubricant layer having a thickness less than one nanometer. The lubricant layer can be formed by a method that includes constructing a magnetic disk; depositing a lubricant layer on the magnetic disk, the lubricant layer comprising two different lubricant materials; and exposing the magnetic disk to a solvent vapor to remove one of the lubricant materials, leaving a layer of the second lubricant material that has a thickness of less than 1 nanometer.

The lubricant layer consists entirely or almost entirely of a bonded lubricant material having a thickness less than one nanometer. The lubricant layer can be as thin as a single molecular mono-layer.

The lubricant layer can be deposited by a process that advantageously allows the disk to have a thicker lubricant layer during burnishing, which ensures that the burnishing process can be effectively carried out without any damage to the disk. Then, after burnishing, the majority of the lubricant layer is removed by exposure to solvent vapor, leaving a very thin layer bonded lubricant.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an enlarged cross-sectional view of a portion of a magnetic media according to an embodiment of the invention;

FIG. 3 is a schematic view of a tool for solvent vapor lubricant removal; and

FIG. 4 is a graph showing radial lubricant thickness uniformity.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

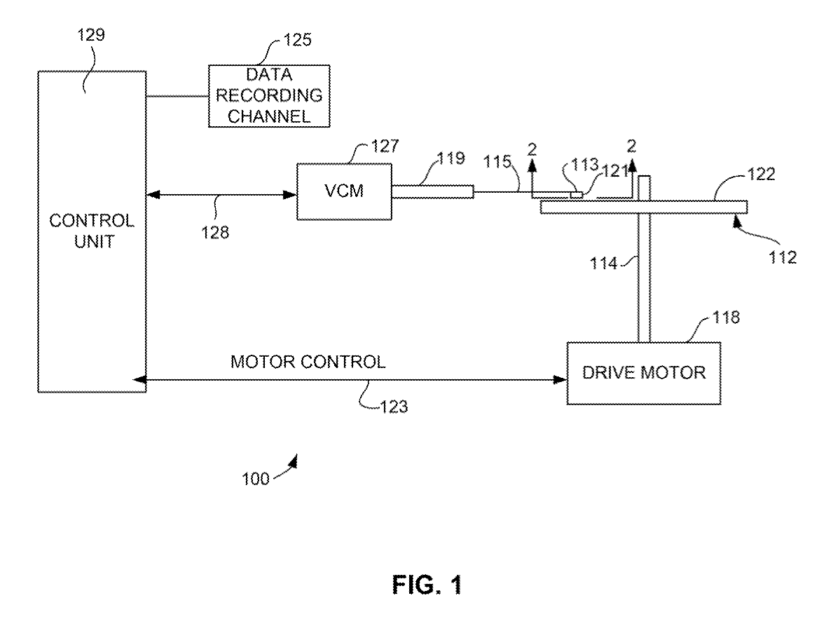

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

As discussed above, the magnetic disk 112 must include various layers formed over the magnetic layer in order to ensure reliable operation of the disk drive system. However, the presence of these layers such as a protective overcoat and a lubrication layer increase the magnetic spacing, which decreases the performance of the system. The present invention mitigates this problem by minimizing the thickness of the thickness of the lubrication layer. The lubrication layer constructed by the present invention can be a thin as a molecular mono-layer.

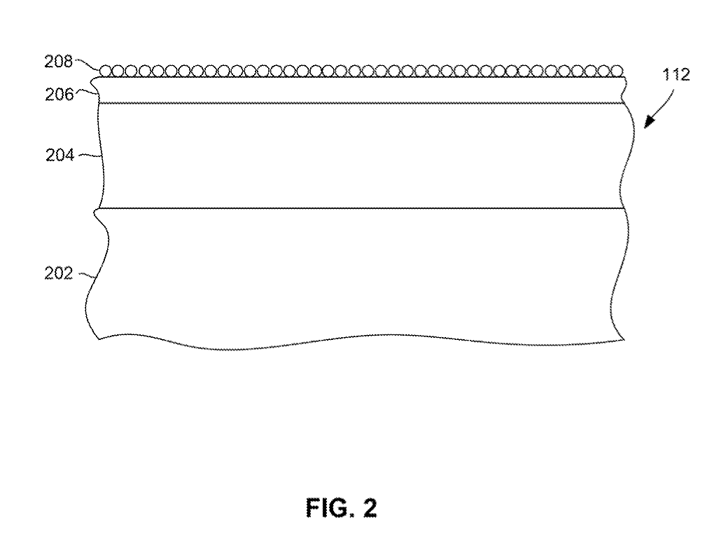

FIG. 2 shows an enlarged cross section of a portion of a magnetic disk 112. The disk includes a substrate 202, a magnetic recording layer 204 formed over the substrate, a protective overcoat 206 formed over the magnetic recording layer and an extremely thin layer of lubricant 208 formed over the protective overcoat 206. As discussed above, the lubricant layer 208 can be as thin as a molecular mono-layer. The lubricant layer can be a perfluoropolyether (e.g. ZTMD) and substantially all the lubricant layer 208 is bonded with the layer beneath it (e.g. the protective overcoat 206). This extremely thin bonded lubricant layer 208 could not previously be formed in a functional magnetic media. However, this structure is made possible and practical by a novel process described herein below.

In order to construct a magnetic media, a magnetic disk substrate 202 is placed in a deposition tool, such as a sputter deposition tool. Various layers of the magnetic media 112, such as the magnetic recording layer 204 are deposited onto the wafer. It should be pointed out that various other layers, not specifically disclosed here could also be deposited and included in the finished disk, such as but not limited to a soft magnetic under-layer, one or more seed layers, etc. In addition, the magnetic media 112 can be formed as a bit patterned media wherein the magnetic recording layer 206 is actually formed as discrete islands or discrete data tracks separated by non-magnetic spaces or non-magnetic material.

After the protective overcoat 206 has been applied, a lubricant material is applied. The lubricant is a combination of two lubricant materials, one that is a bonded lubricant and one that is a non-bonded lubricant. More specifically the lubricant can include a first lubricant that is a functional perfluoropolyether (e.g. ZTMD®) and a second lubricant that is a non-functional perfluoropolyether (e.g. Z15®). The two types of lubricant can be applied by dipping the disk in a bath or could be applied by vapor deposition, although dipping is preferred because it provides better uniformity. Also, the two different lubricants can be mixed and applied at once which saves time and space, or can be applied sequentially.

The deposition of the layers 204, 206 and other layers not shown, inevitably results in certain asperities or a certain amount of roughness that must be addressed in order for the magnetic media to function in a magnetic disk drive. In order to remove these asperities and to provide a sufficiently smooth media surface a burnishing process must be performed. The burnishing process involves spinning the disk while moving a burnishing pad over the surface of the disk. Any asperities or surface roughness will be worn off by the burnishing pad. This pad burnishing is an essential step in manufacturing the magnetic media 112. Poor burnishing results in overcoat scratches and production of solid particles, which lead to poor corrosion-resistance and low glide yield. A certain minimum amount of lubricant is demanded by the burnish process to minimize damage to the disk. The burnish-required lubricant thickness, which can be greater than 1 nm will soon exceed that in the head magnetic spacing (HMS) budget.

To satisfy both requirements (low fly height, and sufficient lubricant thickness during burnish) the lubricant thickness can be reduced after the pad burnish process. The issue is how to reduce the lubricant thickness in a uniform manner to within 0.05 nm) or 0.5 Angstroms). A simple solvent squirting or immersing cannot achieve this. Such a process leads to dripping marks and lubricant lines and generally uneven lubricant application. A solution to these problems is described herein.

The burnishing process requires a significantly thicker lubricant than is needed in the finished disk drive system. The above described dip coating of a dual material lubricant provides a lubricant having a thickness of 12-18 Angstroms that is more than sufficient to ensure good burnishing characteristics with little or no scratching or solid particle production.

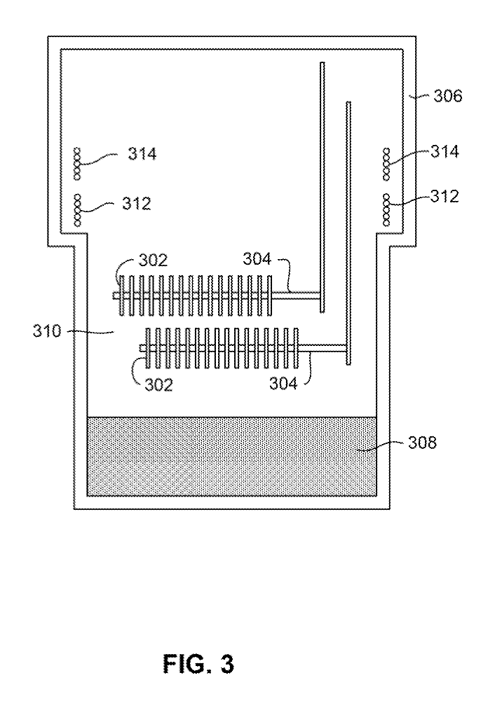

After burnishing has been completed, a majority of the lubricant can be removed by a process that evenly removes all of the lubricant except for a portion of the lubricant that has been bonded to the under-layer 206. The process uses solvent vapor to reduce the media lubricant thickness to a sub-nanometer value after burnishing at a higher lubricant thickness. The final sub-nanometer thickness is determined by the bonded fraction. The bonded fraction remains on the disk surface. Thus, the lubricant remaining on the disk is 100% bonded after de-lubing. However, the final lubricant bonding will decrease to a thermally equilibriated bonded fraction at the drive operational temperature. With reference to FIG. 3, a cassette of media disks 302 that have been burnished as described above are held on a mandrel 304 that rotates the disks 302. A plurality of cassettes of disk 302 and mandrels 304 may be provided as shown to increase throughput of the process. The disks are rotated while being held within a chamber 306 that contains a solvent 308 that is held at or near its boiling point to produce a vapor zone 310 above the solvent. Rather than immersing the disks into the solvent, the disks are held above the solvent in the vapor zone 310 while they are being rotated.

Two stages of cooling prevent the solvent from escaping. This two stage cooling can be provided by a first stage of cooling coils 312 and a second stage of cooling coils 314. The solvent, which can be for example HFE-7100® or Vertrel XF®, has a much lower boiling point (e.g. 50-60 degrees C.) than the lubricant, which can be formed of long-chain perfluoropolyether polymers, such as A20H, Z-dol®, Z-Tetraol®, or ZTMD®. The above process, which uses a mixture of bonded and non-bonded lubricants and subsequent lubrication removal by solvent vapor results in an extremely thin lubrication layer of less than 1 nm. The thickness of the lubrication layer is preferably a molecular mono-layer as described above with regard to FIG. 2.

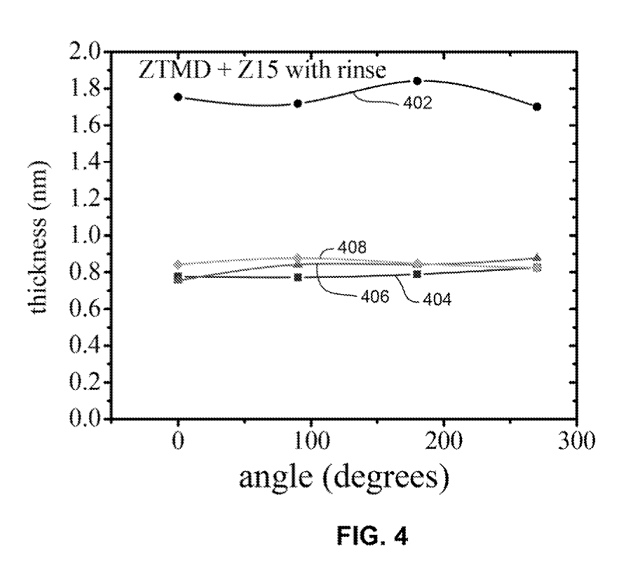

FIG. 4 is a graph showing the radial uniformity after vapor solvent de-lubrication. In the graph, line 402 shows the radial thickness uniformity for a disk that has not yet been burnished and that has not been exposed to vapor de-lubrication. Line 404 shows the radial thickness uniformity for a disk that has not been burnished, but that has been exposed to a solvent vapor for 1 minute. Line 406 shows the radial thickness uniformity after burnishing and after exposing to a solvent vapor for 30 seconds. Line 408 shows the radial thickness uniformity after burnishing and after exposing to a solvent vapor for 1 minute. As can be seen, the above described solvent vapor de-lubrication results in a lubricant layer that has excellent uniformity across the disk.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic media for magnetic data recording, comprising:
a magnetic disk having a lubricant layer formed thereon, the lubricant layer having a thickness between a molecular mono-layer and one nanometer.

2. The magnetic media as in claim 1 wherein the entire lubricant layer is bonded to the magnetic disk.

3. The magnetic media as in claim 1 wherein the lubricant layer is substantially a molecular mono-layer thick.

4. The magnetic media as in claim 1 wherein the lubricant comprises a perfluoropolyether.

5. The magnetic media as in claim 1 wherein the lubricant comprises a perfluoropolyether substantially all of which is bonded to the magnetic disk.

6. The magnetic media as in claim 1 wherein the magnetic disk includes a protective overcoat and wherein the lubricant is bonded to the protective overcoat.

7. A data recording system, comprising:
a housing;
a magnetic media mounted within the housing, the magnetic media further comprising, a magnetic disk having a lubricant layer formed thereon, the lubricant layer having a thickness between a molecular mono-layer and one nanometer.

8. The data recording system as in claim 7 wherein the entire lubricant layer is bonded to the magnetic disk.

9. The data recording system as in claim 7 wherein the lubricant layer is substantially a molecular mono-layer thick.

10. The data recording system as in claim 7 wherein the lubricant comprises a perfluoropolyether.

11. The data recording system as in claim 7 wherein the lubricant comprises a perfluoropolyether substantially all of which is bonded to the magnetic disk.

12. The data recording system as in claim 7 wherein the magnetic disk includes a protective overcoat and wherein the lubricant is bonded to the protective overcoat.

13. A method for manufacturing a magnetic media for data recording, comprising:
constructing a magnetic disk;
depositing a lubricant layer on the magnetic disk, the lubricant layer comprising two different lubricant materials; and
exposing the magnetic disk to a solvent vapor to remove one of the lubricant materials and leaving a layer of the second lubricant material that has a thickness of less than 1 nanometer.

14. The method as in claim 13 wherein the first lubricant material is a non-bonded lubricant and the second lubricant material is a bonded lubricant.

15. The method as in claim 13 wherein the lubricant remaining after exposure to the solvent vapor has a thickness of substantially a single molecular mono-layer.

16. The method as in claim 13 wherein substantially all of the lubricant remaining after exposure to the vapor solvent is bonded to the magnetic disk.

17. The method as in claim 13 wherein the first lubricant material comprises a functional perfluoropolyether and the second lubricant material comprises a non-functional perfluoropolyether.

18. The method as in claim 13 wherein the solvent vapor comprises decafluoropentane.

19. The method as in claim 13 wherein the lubricant layer is deposited onto the magnetic disk by mixing the first and second lubricant materials to form a mixture and dipping the magnetic disk into the mixture.

20. The method as in claim 13 wherein the exposure of the magnetic disk to a solvent vapor comprises partially filling a chamber with a solvent, heating the solvent to a temperature near its boiling point to form a solvent vapor above the solvent and holding the magnetic disk in the solvent vapor.

21. The method as in claim 13 further comprising, after depositing the lubricant layer on the magnetic disk and before exposing the magnetic disk to the solvent vapor, performing a burnishing operation.
